(19) United States
(12) Patent Application Publication
(10) Pub. No.: US 2017/0289328 A1
(43) Pub. Date: Oct. 5, 2017

(54) Automatic Detection of Ear Tip Type

(71) Applicants: Scott L. McGregor, Campell, CA (US); Akien MacIain, Oakland, CA (US)

(72) Inventors: Scott L. McGregor, Campell, CA (US); Akien MacIain, Oakland, CA (US)

(73) Assignee: Tridimensional Innovations, Inc, Campbell, CA (US)

(21) Appl. No.: 15/376,299

(22) Filed: Dec. 12, 2016

Related U.S. Application Data
(60) Provisional application No. 62/266,725, filed on Dec. 14, 2015.

(51) Int. Cl. H04M 1/60; H04M 1/725

(52) U.S. Cl. CPC H04M 1/6058; H04M 1/72563; H04M 1/585

(57) ABSTRACT

An ear tip to audio headset connection system. The invention support both open ear fit, and closed ear fit ear tips, and distinguishes which is currently attached. Open ear and closed ear configurations normally generate differing audio signal characteristics. Including differing levels of overall volume, as well as different amounts of attenuation across the audio spectrum. Our invention adjusts the audio signal limiter, equalizer and other audio settings differently for each type of earpiece, compensating for their inherent differences.

### BACKGROUND

1. Field of the Invention:

The present invention is directed to the manufacture and operation of in ear audio products, including both open fit and closed fit ear tips.

2. Description of the Related Art:

In ear audio headsets typically have removable ear tips.

Some of these ear tips, such as Apple ear buds, are standardized sizes and shapes. Because ears vary a lot in size and shape, these standardized sizes and shapes typically don't seal the ear canal, and the signal generated by the speaker leaks out of the ear, while ambient noise also enters. Signal may have to be boosted to a higher volume to hear the signal over the ambient noise. Also in an open ear setting different parts of the audio spectrum are attenuated to different degrees. To compensate, an equalization filter is often applied that boosts some of the signals (e.g. the bass) relative to less attenuated part of the spectrum (e.g. the treble).

Other ear tips, such as custom fit ear tips often used in hearing aids and musician's monitors, are molded to the shape of the individual user's ears. These ear tips seal the ear canal, ensuring more of the audio signal reaches the listener's ear drum. With a lower ambient noise threshold, users will typically want the signal volume to be lower. Also because the attenuation of the signal across the spectrum is different in a closed ear than in an open ear, the equalization filter applied would typically be different.

To date, headsets have accommodated these different audio characteristics by either being designed strictly for open ear tips or for closed ear tips, but not for both. If a headset manufacturer wanted to offer both kinds of headsets, they would offer multiple headset models. This reduces volume production for each model, leading to higher unit costs, and causes retailers to carry extra inventory by carrying multiple models.

Similarly, different “signature line” models that differ only in cosmetic features have the same problem, each model will be more expensive than if there had only been a single line, and retailers face the need to carry more total on hand, but typically run out of popular models, yet they get stuck with “stale inventory” of lines that turn out to be less popular.

Additionally, the actual frequency response and other audio characteristics may vary depending on the relative geometries of the ear canal and concha of the user's ear to the ear tip, and because ear shapes vary a lot from person, a standard sized and shape ear tip might yield different audio characteristics to different people.

### SUMMARY

In each embodiment of the present invention, the ear tip or ear tips that attach to the headset are removable and interchangeable, although audio characteristics of each different type of ear tip vary.

An advantage of one embodiment of our manufacturing process is that by manufacturing the earpiece and portions of the headset (typically the cosmetic exterior) on demand, stale inventory problems can be eliminated, while the number of signature lines offered can greatly increase.

Different ear tips may have different audio characteristics, and by distinguishing which type of ear tip is connected the sound production characteristics can be adjusted to be appropriate to the characteristics of that ear tip.

An advantage of our invention is that open ear ear tips and closed ear ear tips convey different proportions of sound to the ear drum, which is perceived as different volume levels.

Another advantage of our invention is that volume level limits can be adjusted downward in closed fit situations to prevent overly loud sounds from damaging the ear drum.

Another advantage of our invention is that volume level limits can be adjusted upward in open fit situations to enable a louder signal relative to ambient noise to be perceived by the listener.

Another advantage of our invention is that different ear tips will cause different parts of the audio spectrum to be attenuated non-proportionately, but an equalization function can be applied to the signal to correct it so it is performed appropriately.

In one embodiment of the present invention, a method for attaching interchangeable ear tips to a headset is provided that enable the headset to electrically detect the type of ear tip using mechanical means.

In another embodiment of the present invention, a method for attaching interchangeable ear tips to a headset is provided that enable the headset to electrically detect the type of ear tip using electrical means.

In another embodiment of the present invention, a method for attaching interchangeable ear tips to a headset is provided that enable the headset to electrically detect the type of ear tip using magnetic means.

In another embodiment of the present invention, a method for detecting how the audio characteristics of the current ear tip system is performing is achieved by generating a test signal, some or all of which may be outside the range of human hearing, and detecting the frequency-volume curve received by the headset microphone.

### BRIEF DESCRIPTION OF THE DRAWINGS

FIG. 1 shows the flow chart of the process steps of our invention. The process starts , 110, by determining which of multiple ear tips is currently attached to the headset. There are several different ways headsets may be distinguished, including mechanically, electrically, magnetically, and acoustically, as explained below. Each kind of linkage allows the device to determine which earpiece is connected, and the audio characteristics that ear tip creates.

Using the linkage characteristics, the earpiece type is determined, 120, and different volume limiter and equalizer settings will be set appropriately.

Non-occluded (open ear) ear tips do not seal the ear canal. As a result, more of the signal energy is dispersed outside the ear, and more ambient noise is let in. To hear the signal over the increased noise, and because less signal reaches the ear drum, the volume limiter may be set higher. Because some parts of the audio spectrum (particularly the bass spectrum) are disproportionately attenuated in open fit situations compared to other parts of the spectrum (the treble) an equalizer treatment may be applied to the signal to boost the parts of the spectrum that are attenuated most and decrease volume of any parts that have enhanced volume, 130.

Occluded (closed ear) ear tips do seal the ear canal, therefore the full power of the amplified signal is delivered to the ear drum, while ambient noise will be masked. Therefore, for closed fit ear tips, volume limiter settings are set lower, and equalizer settings are adjusted for typical closed ear conditions, 140.

In some cases we may detect an ear tip that only partially occludes the ear canal, 150. In headsets that have both a speaker and a microphone, the amount of volume drop, and differences across the spectrum can be determined by measurement, 150.

The audio spectrum produced can be boosted or attenuated to ensure the proper volume in each part of the spectrum is delivered to provide balance, 160.

Once the audio characteristics, including volume limiters and equalization, are adjusted to levels appropriate for those ear tips, the adjustment process is complete, 170.

FIG. 2 shows a mechanical linkage. In our invention the ear tip slips over or under a component of the earpiece we refer to as the post. The post and ear tip may be any size or shape, but they are sized so that one securely slides over the other. They may be held next to each other by a friction fit, or by a locking fit, as desired by the manufacturer. In this figure we show the ear tip, 200, as being the larger component, which slides over the post, 210. Embedded inside one of the components (in this embodiment within the post), is an electrical circuit, 220, which is normally in its open position.

The mechanical linkage is able to distinguish between two types of ear tips by using a keyed design, in which one portion of the ear tip, called the key, is manufactured to be higher , 250, for one type of ear tip, and lower or missing entirely in a second kind of ear tip, 260. The higher or lower tip presses against a switch component, 240, which completes the circuit in one position, but not in the other position. The switch is attached to another component, such as a spring, 230, which causes the switch to be in either a default open or closed position when the high key is not present, but changes that state when the high key is present.

More than two types of ear tips may be distinguished by having multiple switches which define a binary number consisting of several on and off digits.

FIG. 3 shows an electrical linkage. As with the mechanical linkage, the post, 310, may fit over or under the ear tip, 300 and 320. In this illustration we show the post as interior to the ear tip. Also as in the mechanical linkage, we have an open circuit, 310 on one of the components; in this case it is part of the post. The other component, in this case the ear tip, is either conductive, 320, or non conductive 310. Because the post and ear tip are in direct contact the circuit is closed when both components are conductive, but not otherwise. As before, more than two types of earpieces can be distinguished by employing multiple circuits, that encode a binary number.

In addition to using multiple circuits and a binary (digital) encoding, the conductive component can have different electrical properties, such as differing electrical resistance. In this case, you can use an analog sensor such as an ohm meter, volt meter, or amp meter to determine which ear tips is being use.

In FIG. 4, we again see the post, 410, and 400 ear tip sleeve arrangement. As before, it is unimportant which is the outer and which is the inner object, but in this example we assume that the post is the inner object, and the ear tip the outer object. Also, as before we have an open circuit, 420. In this case we have a magnetic switch 430. If a local magnet, 450, is present the current flows, if not, 460, the current does not pass. Also as before, a series of circuits can be used to create a binary coding, or an analog sensor that detects the magnetic strength of the magnet to discriminate more than just two earpiece cases.

In FIG. 5, we see that the ear, 500, and a close fit ear tip headset, 520, and an open fit ear tip headset, 525. Both headsets have a speaker, 530, that generates a signal, 510 that is heard by the ear. In the case of the closed ear headset the ear canal is sealed, and very little of the signal leaks out, 540. In contrast, the open ear headset, 525 does not seal the ear, so more of the signal leaks out 570.

Both headset also have a microphone, 560, exterior to the ear canal. The ambient sounds, 550 and 580, including the leaked signals, 540 and 570, are received by these microphones. However, the leaked signal that reaches the closed ear microphone, 550, will be much more attenuated in volume than the leaked signal that reaches the open ear microphone, 580. Also the audio volume vs. Spectrum curve will be altered in different ways by open vs. Closed ear systems.

### DETAILED DESCRIPTION

Our invention includes a new way to manufacture headsets with custom fit earpieces, so that they can be made on demand. Because the earpieces are one of a kind manufactured products, made on demand, we can vary them and other cosmetic features of the headset to create large numbers of visual designs which might celebrate a music artist, a sports team, an organization the buyer identifies with, or any other visual badge expressing their identity.

Our invention is also an ear tip to audio headset connection system. As noted in the Related Art section, there have been both open ear and closed ear headsets in the market for a long time, but these fitting styles have differing effects on the overall volume and attenuation of frequencies across the spectrum.

So if a user switched from open ear fit to closed ear fit (or vice versa) the headset would generate acoustic spectrum and volume levels that were inappropriate for that kind of acoustic chamber. Manufacturers dealt with differing demands by designing different models of headset for different kinds of ear tips.

In our invention we enable a single headset to support use of both open ear and closed ear tips. Our invention enables the headset electronics to sense which kind of ear tip is connected, and to adjust the audio characteristics of the generated signal that is produced by the speaker.

Using a single set of electronics allows a manufacturer to gain economies of scale, even while the headsets can be customized for either open fit or closed fit use.

With our system, we can set the volume limiter lower when closed ear tips are detected, protecting the user's ears from overly loud volumes. Such volume settings might be fine in open ear use where a lot of signal is lost to outside the ear, but they are too loud in the confined closed ear case, and can be painful and damaging to long term hearing loss.

Conversely, if an open ear tip is detected the volume limiter might be adjusted louder, to compensate for greater ambient noise levels.

In addition, to adjust the overall volume limit, we know that signal loss across the spectrum is not uniform. In open ear situations bass frequencies are more attenuated than treble frequencies. Since our invention can detect which kind of ear tip is in use, it can also change equalization filter tables to correct for these differences.

In our invention we have identified 4 ways to detect the type of headset that is currently attached, so that the electronics can be signaled and choose the right volume and equalization settings. Other audio characteristics (e.g. Phase shifting) that might vary from one model of ear tip to another can also be adjusted to compensate between the two settings.

The first means of distinguishing between the two different models of earpieces is to code them. Typically you only need to distinguish between two ear tip models (open and closed ear versions), so a single binary distinction is usually all that is necessary. However, more models can be distinguished by either employing more than one binary switch, or using analog methods.

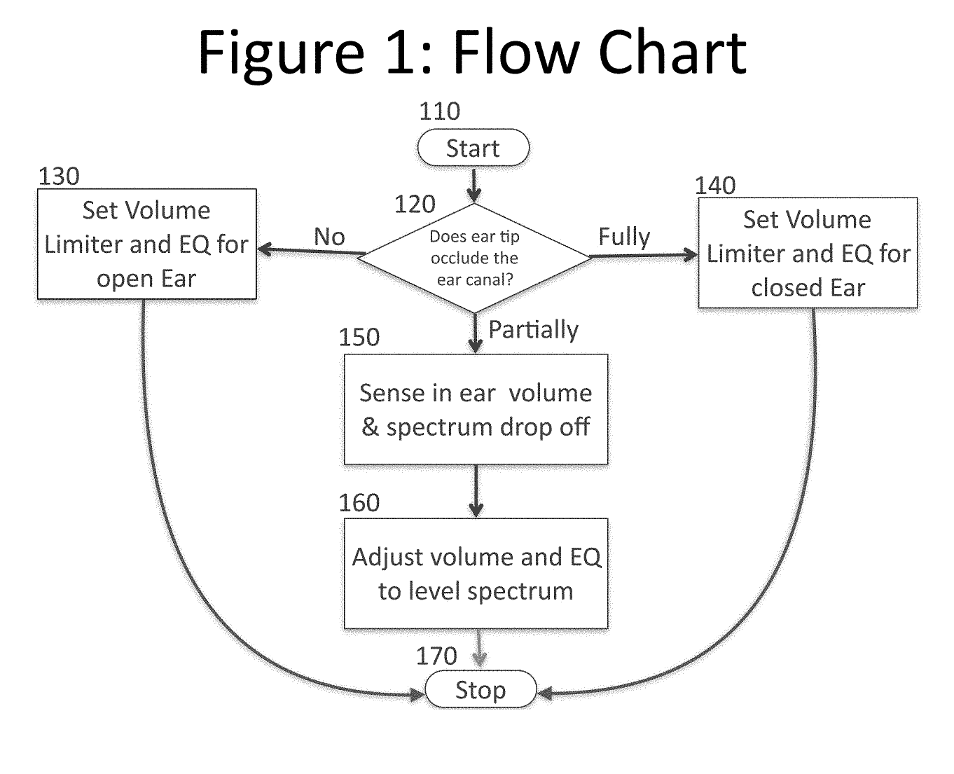

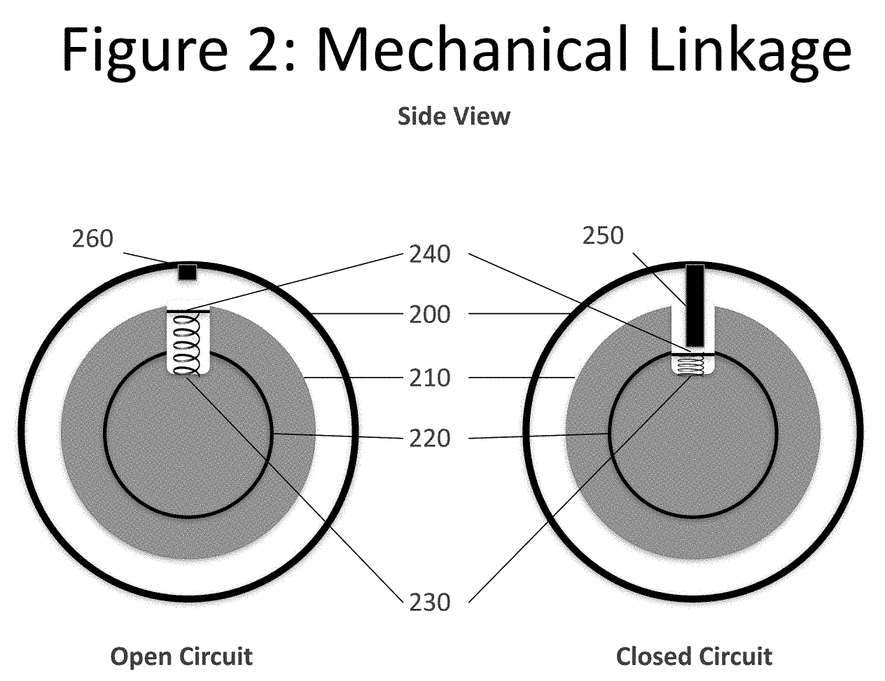

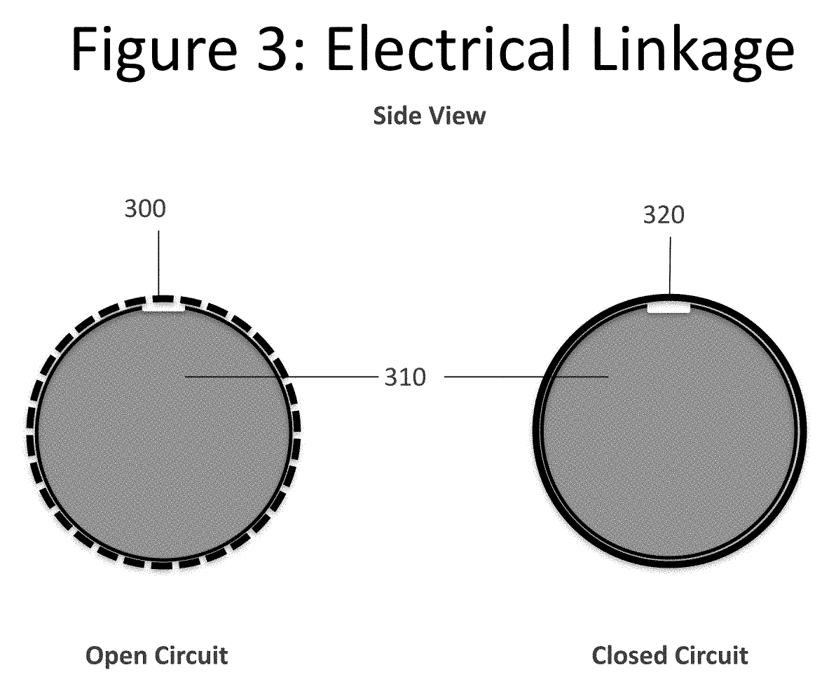

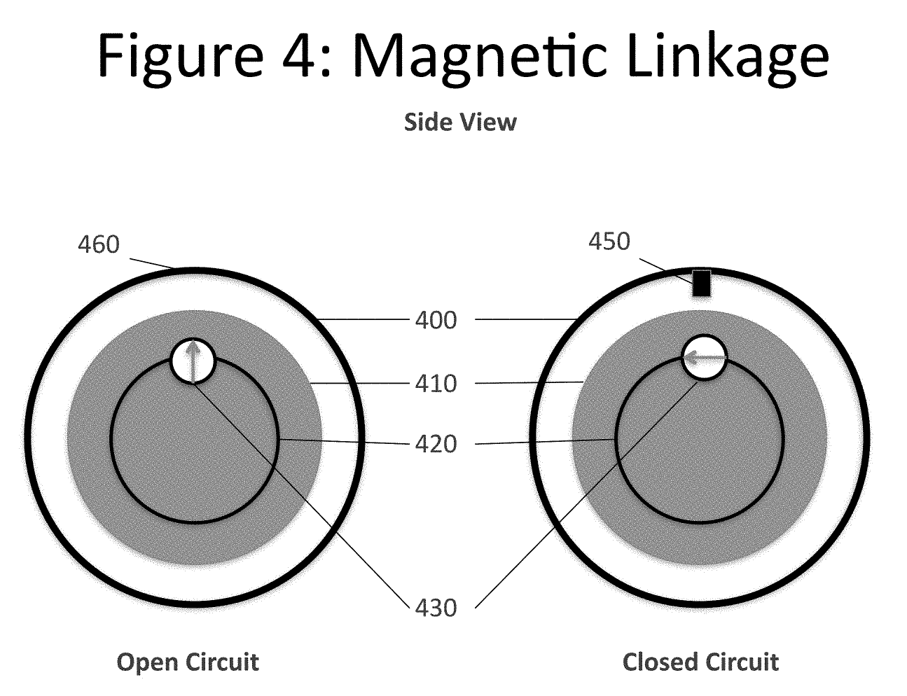

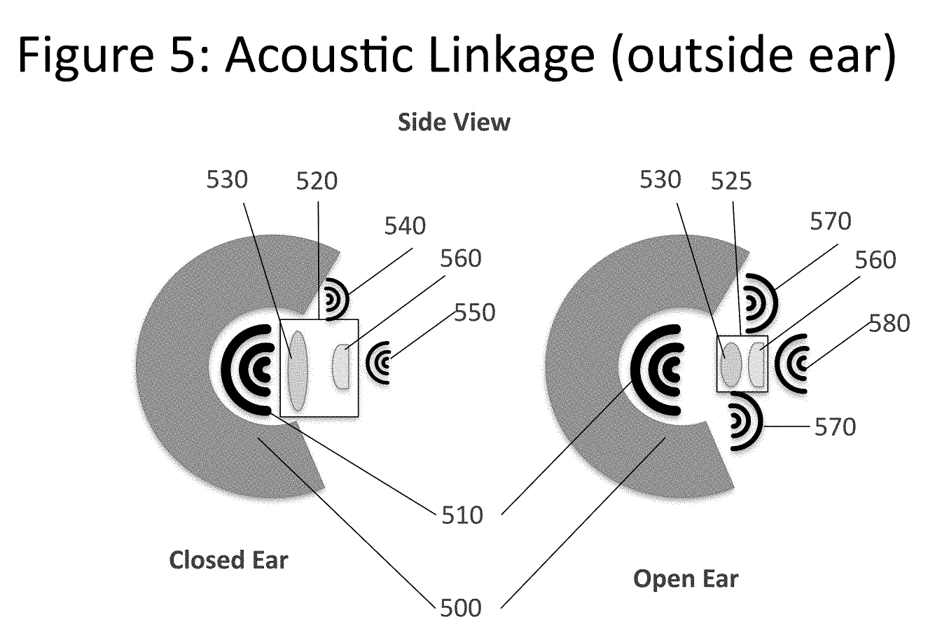

One way to encode the ear tip models assign the number zero to the open ear model, 130, and the number 1 to the closed ear model, 140, as we see in the flow chart in FIG. 1. In some cases we may choose to not make a pure binary decision, but we might detect partially occluded ear conditions, 150, and adjust the volume and equalization based on actual measurements taken in real time.

In one embodiment, shown in FIG. 2, The ear tips can be manufactured with a special physical “key” feature, 250, that sticks out, and is present only in one of the ear models. If present, an electrical circuit would be closed, and this signal tells the electronics which ear tip is connected. If that key is not present the signal is open and the other ear tip model is detected. A simple OR gate can then select which volume limiter and equalizer table should be used. Or if more than 2 models of ear tips are supported, multiple circuits can be checked, a binary number determined, and the proper volume and equalization settings selected from an indexed look up table.

In a second embodiment, shown in FIG. 3, the physical key is eliminated, and the electrical conductivity of the ear tip itself determines which ear tip is sensed (300 vs 320. Again the simple case is just a binary selection based on an open or closed circuit, or multiple circuits which encode a binary lookup. However, it is also possible to encode the ear tip model number using analog electrical characteristics such as having ear tips with different resistors in them.

In a third embodiment, shown in FIG. 4, we do not use electrical connectivity directly, nor physical keying. Instead we place a magnet or magnets, 450, in the ear tip and we employ a sensor, 430, which closes the circuit in the presence of a magnetic field and opens the circuit when the field is not present. As with the electrical conductance model, we can not only use multiple circuits to encode more than two binaries model numbers but we can also use analog characteristics of the magnetic field to select a model number.

One reason you might want to support more than two ear tip models is that it is sometimes an ear tip is designed to only partially occlude the ear, or to dampen certain ambient noise frequencies preferentially. One reason a listener want a headset to be only partially block ambient noise is that it might be used in traffic, where it is important to hear very loud sounds, such as a siren, screeching brakes or an approaching vehicle. In other cases certain parts of the spectrum might be blocked preferentially, for instance, in a loud industrial setting, it might be desirable to hear more ambient sounds in the range of a typical speaking voice in order to hold a conversation with a co-worker, but it would be desirable to dampen ambient sounds (caused my machinery) outside that range. Another example would be use by people using firearms, such as military, security forces and hunters, the loud and sudden onset of the firing can damage hearing if not significantly dampened, but communication with nearby people is critical to avoid accidental shootings.

This partial dampening is typically done through the use of “ports” that connect the inside of the sealed ear space with the outside of the ear. Sound can leak through this port in both directions, but the size, shape, and other characteristics of the port mechanism can determine how it alters the frequencies passed in each direction.

Many audio headsets are used for two way communications, they therefore have both a speaker, 530, close to the ear canal and a microphone, 560, outside the ear. In headsets with this configuration, we do not need to encode the ear tip model to determine its effect on the overall volume and on the attenuation of the speakers, instead, we can detect the volume of differ spectra detected by the microphone. From the detected volumes at different points of the spectra we can construct a model of what the sound is like inside the ear. Using that model, we can adjust overall volume and spectra accordingly.

An advantage of this embodiment is that we need not rely strictly on keying. Another advantage is that should the ear tip imperfectly seal the amount of leakage might vary somewhat from ear to ear. This is particularly true in the case of open ear tip designs, where a smaller ear might have a more snug fit that blocks more of the ear canal while a larger ear, or an ear with where the ear canal has a different placement relative to the tip might have a looser fit that attenuates signal more.

In this embodiment, in the lab prior to deployment, we test the inside and outside spectrum and volumes under a number of occlusion conditions. From this we determine various spectra signatures detected by the microphone and spectra that are delivered to the ear drum. Different equalization tables and volume limiting settings can be created to adjust each tested configuration.

In use, we can have our speaker send out a test signal at various frequencies. The volumes detected at the microphone are measured, and the closest tested configuration is selected for volume and equalization table settings.

The range of human hearing is generally between 15 Hz and 20 kHz. However, speakers and microphones can produce and receive sounds outside this range. By generating and detecting test tones outside the range of normal hearing we can create test signals of various volumes without annoying the user. If desired, we can frequently or even continuously generate ultrasonic or infrasonic tones to detect any change in the degree of occlusion which might occur as a result of bumping the earpiece.

An audible spread spectrum tone can also be generated to detect in real time the current levels of frequency response across the entire spectrum. This tone would generally be generated at start-up but could be generated at any time, if the user wishes to re-calibrate the system.

It should be noted that communication headsets have long employed anti-sidetone circuitry to prevent feedback between the speaker and microphone. This would still be employed to avoid “howling” feedback.

Throughout this disclosure we often speak of an equalization table. This refers to an array describing amount of relative boost or dampening of the volume of the signal at various different frequencies. Historically, this was done by defining an array consisting of series of frequency ranges and assigning each a column in the table, often corresponding to a physical slider in a sound board. The value of each entry in the table represented the relative volume boost of that frequency.

The entire set of frequencies within each corresponding frequency band might be boosted or dampened by the same fixed value, creating a “stair step” histogram of volume by frequency. Other implementations of equalizers assigned the volume setting to the midpoint of the range, and varied the volume between mid points linearly, creating a “sawtooth” plot of volume by frequency. Yet other implementations seek to fit smoothed continuous curves, such as splines to the spectra. In this case, rather than a lookup table the embodiment of the equalizer might actually be simply a mathematical function with a set of parameters. Our invention is independent of how the equalization tables are actually implemented.

It is often assumed that the most desirable frequency volume curve is “flat”, that is, each reference tone across the spectrum, would be received with the identical volume. Many researchers have found that users often prefer non-flat curves. Some of these preferences are idiosyncratic to the user, while others are dependent on the genre of music.

Our invention can also be used with non-flat equalization settings, if desired.

1. An ear tip to audio headset connection system comprising a plurality of different ear tips that can be connected to the headset, where said ear tips may differently affect the overall volume, the frequency-volume curve across the spectrum, or other audio characteristics, said headset system being able to detect which ear tip is attached, and correspondingly adjust the volume limiter, equalization table, or other characteristics of the speaker to compensate for the differences caused by said differing ear tips, or by the fit of said ear tips to the geometry of the user's ear, or their interaction with ambient noise.

2. The ear tip connection system in claim 1, in which physical keying is used to determine the specific ear tip model connected.

3. The ear tip connection system in claim 1, in which electrical conductance is used to determine the specific ear tip model connected.

4. The ear tip connection system in claim 1, in which magnetic is used to determine the specific ear tip model connected.

5. The ear tip connection system in claim 1, where acoustic characteristics of a test signal are used to determine the properties of the current ear tip.

6. A method for adjusting sound characteristics generated by an audio device, such as volume and frequency-volume distribution, based upon the characteristics of the recognized attached ear tip and how those characteristics alter the volume and frequency-volume distribution that is delivered to the listener.

7. A method for adjusting sound characteristics generated by an audio device, such as volume and frequency-volume distribution, based upon the characteristics of a test signal generated by that speaker and received by a nearby microphone.
